(19) United States
(12) Patent Application Publication
(10) Pub. No.: US 2006/0095949 A1
(43) Pub. Date: May 4, 2006

(54) Method and computer program for providing visual information to a viewer

(76) Inventors: Adele Whish-Wilson, Prahran (AU); Guy Franklin, Prahran (AU); Andrew Rowsell, Prahan (AU)

Correspondence Address: TAFT, STETTINIUS & HOLLISTER LLP, SUITE 1800, 425 WALNUT STREET, CINCINNATI, OH, 45202-3957, US

(21) Appl. No.: 10/524,734

(22) PCT Filed: Aug. 15, 2003
(86) PCT No.: PCT/AU03/01039

§ 371 Date: Sep. 16, 2005

(30) Foreign Application Priority Data
Aug. 15, 2002 (AU) 2002950805

(51) Int. Cl. H04N 7/173

(52) U.S. Cl. 725/105

(57) ABSTRACT

The present invention relates to video transmission systems and provides a method of providing visual information to a viewer, comprising the steps of: (a) receiving at a receiver, a stream of video data transmitted from a video camera; (b) receiving and monitoring the stream at a server connected to the receiver; (c) transmitting the stream from the server to one or more remote viewers over a communications network; and (d) transmitting a snapshot image to one or more remote viewers in response to the detection of a characteristic in the stream. The invention finds application in areas such as the online presentation and sale of goods and services.

### FIELD OF THE INVENTION

The present invention relates to video transmission systems. In particular, the invention relates to methods and systems for providing streamed video and snapshot images to a viewer over a communications network.

### BACKGROUND OF THE INVENTION

The transmission of both prerecorded and live video over communications networks such as the Internet is known. Live video can be transmitted over the Internet using a low cost digital camera, known as a webcam. To improve the quality of the transmitted video, systems are being developed allowing a conventional video camera such as a camcorder to be used. Also, wireless technology allows a camera operator to roam with the camera to capture video, that can be wirelessly relayed to a remote server for transmission over the Internet. Such solutions have found application in the marketing of goods and services, where vendors are able to transmit live video images of their products along with commentary to prospective customers over the Internet.

It is also known to transmit snapshot images of particular video frames over the Internet. For example, U.S. Pat. No. 6,172,672 describes a system for delivering video from a server to a client over a limited bandwidth communications medium. A snapshot feature allows the client to select a button on their user interface to request snapshot image. In response to the selection a message is transmitted to the server that identifies the particular frame that was displayed at the client when the button was selected. The server then locates the particular frame identified in the message and transmits it to the client. The snapshot image may be of better quality than the original video frame, because transmission of the video is suspended whilst the snapshot is transmitted to take account of the limited bandwidth.

There will be an elapse of time between when the client decides to request a snapshot, the physical act of pressing the button and the recognition of that event by a processor. Although the period of the elapse may be small, it is still of significance when compared to the rate that video frames are refreshed on the client's display. Accordingly, there is a possibility that the snapshot image delivered to a client by the system of U.S. Pat. No. 6,172,672 will not accord with the client's expectations. This problem would be particularly apparent if the system of U.S. Pat. No. 6,172,672 was adapted to transmit live video images of goods or services to a prospective customer. If the customer did not receive a snapshot of a dose up image of the product when expected the chances of making a sale decrease. Problems could also arise if the system was used in a medical context.

It would therefore be advantageous to improve video transmission systems that deliver both streamed video and snapshot images over a communications network.

In this specification, where a document, act or item of knowledge is referred to or discussed, this reference or discussion is not an admission that the document, act or item of knowledge or any combination thereof was at the priority date:
(i) part of common general knowledge; or
(ii) known to be relevant to an attempt to solve any problem with which this specification is concerned.

### SUMMARY OF THE INVENTION

According to a first aspect of the present invention there is provided a method of providing visual information to a viewer, comprising the steps of:
(a) receiving at a receiver a stream of video data transmitted from a video camera;
(b) receiving and monitoring the stream at a server connected to the receiver;
(c) transmitting the stream from the server to one or more remote viewers over a communications network; and
(d) transmitting a snapshot image to one or more remote viewers in response to the detection of a characteristic in the stream.

The present invention differs from and provides advantages over the system described above by transmitting a snapshot in response to the detection of a characteristic in the stream rather than in response to a request received through the communications network from a viewer. Thus the present invention allows for the partial automation of the snapshot transmission process.

In this specification, including the claims, the term “characteristic” refers to any information derivable from the data stream transmitted by the video camera to the receiver. For example, the characteristic may be a signal indicating that a snapshot request has been initiated at the video camera, such as by activating a button on the camera.

Alternatively the characteristic may be an attribute of the visual content of the stream such as the repetition of a of a substantially static image in the stream. A repeated static image may be the result of the camera operator pointing the camera at a particular object for an extended period of time. Thus the invention allows the operator to automatically emphasise an aspect of the video content by providing a snapshot image to viewers.

Typically the static image is detected by comparing a frame to a plurality of other frames in the stream wherein the substantially static image is detected when the frame is similar to each of the other frames. Preferably the frame was captured by the video camera after each of the other frames.

The method may further include the steps of:
(e) including the frame in the plurality of other frames after it has been compared to the plurality of other frames; and
(f) removing a frame from the plurality of other frames.

Preferably, the frame removed from the plurality of other frames is the earliest frame captured by the video camera.

The frame may be similar to another frame notwithstanding differences between the frames, where those differences are within a prescribed difference tolerance.

Advantageously, the snapshot image transmitted to the viewer is an average frame calculated from the frame and each of the other frames.

The method may further include the steps of:
(g) comparing the frame to the most recently transmitted snapshot image; and
(h) transmitting a further snapshot image only when the frame and the most recently transmitted snapshot image are sufficiently different.

The snapshot images may be stored at a client device of the viewer for retrieval and viewing, and may be of a higher resolution than the frames in the stream.

According to a second aspect of the present invention there is provided computer program code comprising:
(a) instructions for receiving a stream of video data;
(b) instructions for transmitting the stream to one or more remote viewers over a communications network;
(c) instructions for monitoring the stream; and
(d) instructions for transmitting a snapshot image to one or more remote viewers in response to the detection of a characteristic in the stream.

The characteristic may be a signal indicating that a snapshot request has been initiated at the video camera. Preferably, the initiation is by activation of a button on the video camera.

Alternatively, the characteristic may be an attribute of the visual content of the stream.

Typically, the attribute is the repetition of a substantially static image.

The computer program code may further include instructions for detecting the substantially static image by comparing a frame to a plurality of other frames in the stream, wherein the substantially static image is detected when the first frame is similar to each of the other frames. Typically, the frame was captured by the video camera after each of the other frames.

The computer program code according may further include:
(e) instructions for including the first frame in the plurality of other frames after it has been compared to the plurality of other frames; and
(f) instructions for removing a frame from the plurality of other frames.

The frame removed from the plurality of other frames is usually the earliest frame captured by the video camera.

Advantageously, the computer program code further includes instructions for determining that the frame is similar to another frame notwithstanding differences between the frames where those differences are within a prescribed difference tolerance.

The computer program code may further include instructions for transmitting an average frame calculated from the frame and each of the other frames to the viewer as the snapshot image.

The computer program code may further include instructions for storing each transmitted snapshot image at a client device of the viewer for retrieval and viewing.

The computer program code may further include instructions for providing a snapshot image having a resolution higher than the resolution of the frames in the stream.

### BRIEF DESCRIPTION OF THE DRAWINGS

A preferred embodiment of the invention will now be described with reference to the accompanying drawings wherein:

FIG. 1 is a schematic diagram illustrating the server and viewer communication via the Internet;

FIG. 2 is a schematic diagram of the components of the server;

FIG. 3 is a flow chart illustrating the high level steps of the method of the present invention;

FIG. 4A is a flow chart illustrating the steps of the method carried out in detecting a snapshot request initiated at the camera.

FIG. 4B is a flow chart illustrating the steps of the static image detection algorithm of the present invention;

FIG. 5 is an illustration of the cyclic image buffer used to deliver snap shot images to a viewer; and

FIG. 6 is an illustration of a viewer interface for the received visual information.

### DETAILED DESCRIPTION OF PREFERRED EMBODIMENTS

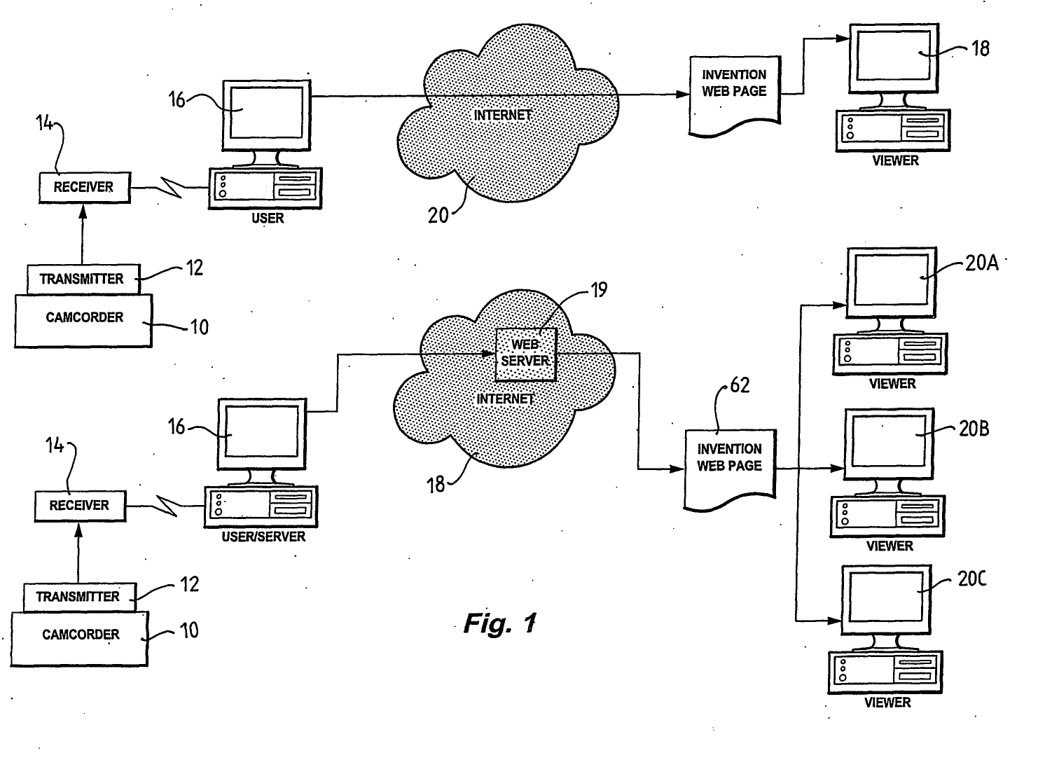

Turning to FIG. 1, a video camera such as a camcorder 10 can be operated to capture a stream of video in a conventional manner. Connected to the camcorder 10, for example through the accessory shoe, is a transmitter 12 that receives the video stream from the camcorder 10 and wirelessly transmits it to a receiver 14. Wireless transmission between the transmitter and receiver may be achieved through any convenient wireless protocol including Radio Frequency, Bluetooth™ or a wireless LAN protocol such as 802.11. A server 16, connected to the receiver 14, runs a web server program 19 which allows video from the receiver 14 to be viewed over the Internet 18 by a plurality of viewers, who access the video through a client device 20A-20D such as a personal computer. The server 16 may be any suitable hardware and software combination as understood by those skilled in the art. The client devices 20A-20D run a browser program, such as Microsoft Internet Explorer, that allows the video to be streamed from the server 16 to the client device and viewed on the client device through a web page 62 accessible to the client devices 20A-20D. The details of web based client-server communications and protocols are not essential to an understanding of the present invention and will not be further elaborated here.

Turning to FIG. 2 of the components of the server 16 of the present invention are described in further detail. The server 16 includes a processor 22 for executing the instructions of a computer program 23 stored in a Random Access Memory “RAM” 24 connected to the processor 22 via a bus 27. An operating system 25 is also stored in the RAM 24 in a conventional manner.

The computer program 23 includes instructions which when executed by the processor control a wireless receiver card 14, and a video capture device 26 that are also connected (directly or indirectly) to the processor 22. The wireless receiver card 14 receives electromagnetic signals from the transmitter 12 over which the stream of video data from the camcorder is modulated. In a conventional manner, the stream of video data includes encoded visual content and other information used, inter alia, to control the display of the visual content on a display device such as a computer monitor. As the stream of video data from the camcorder may be in analogue form, the video capture device 26 is used to digitize the visual content of the video data into a plurality of pixellated frames and to extract any other information carried by the stream of video data.

The computer program 23 also includes instructions which when executed by the processor 22, control an area of memory 30 (primary and/or secondary memory) for storing the most recently transmitted snapshot image. This aspect of the invention is considered in more detail below.

The computer program 23 also includes instructions which when executed by the processor 22, monitor the stream of video data and detect characteristics in the stream which trigger the transmission of snapshot images to one or more remote viewers connected to the server 16 via the web server program 19. As will be described in further detail below the characteristic may be a signal in the stream of video data. For example, the signal could be an indication that a snapshot request has been initiated at the video camera, or that the temperature or humidity surrounding the camera has exceeded a certain value. The signal could also be a timing signal to forward snapshots at periodic intervals.

Alternatively the characteristic may be an attribute of the visual content of the stream of video data. In the preferred embodiment, the characteristic is the repetition of a substantially static image in the stream, however the computer program 23 could also detect other attributes of the visual content of the stream. For example the computer program could be adapted to detect when a face enters a frame, so that a snapshot is triggered to save the faces of all people entering a building. Additionally the computer program could be adapted to detect certain intensities of light, so that snapshots are taken inside a room before the lights are switched off. Similarly, the transmission of snapshots could be triggered when certain colours are detected

The computer program 23 also utilises an area of memory (preferably primary) to implement a cyclic image buffer 28 when monitoring the stream of video data to detect the repetition of a substantially static image. The size of the cyclic image buffer 28 may be varied by the user of the system to store a predetermined number of frames outputed by the video capture device 26. As is described in further detail below, the cyclic image buffer is used to detect the repetition of a static image in the video stream, by comparing a frame to each frame stored in the cyclic image buffer 28. It will be realised that the size of the cyclic image buffer 23 will necessarily effect the frequency of static image repetition, in that the chance of a static image being repeated generally decreases as the length of the monitored video stream increases. Of course the expected frequency of static image detection can be varied by adjusting the size of the cyclic image buffer (and consequently the length of the video stream) to suit different applications of the invention.

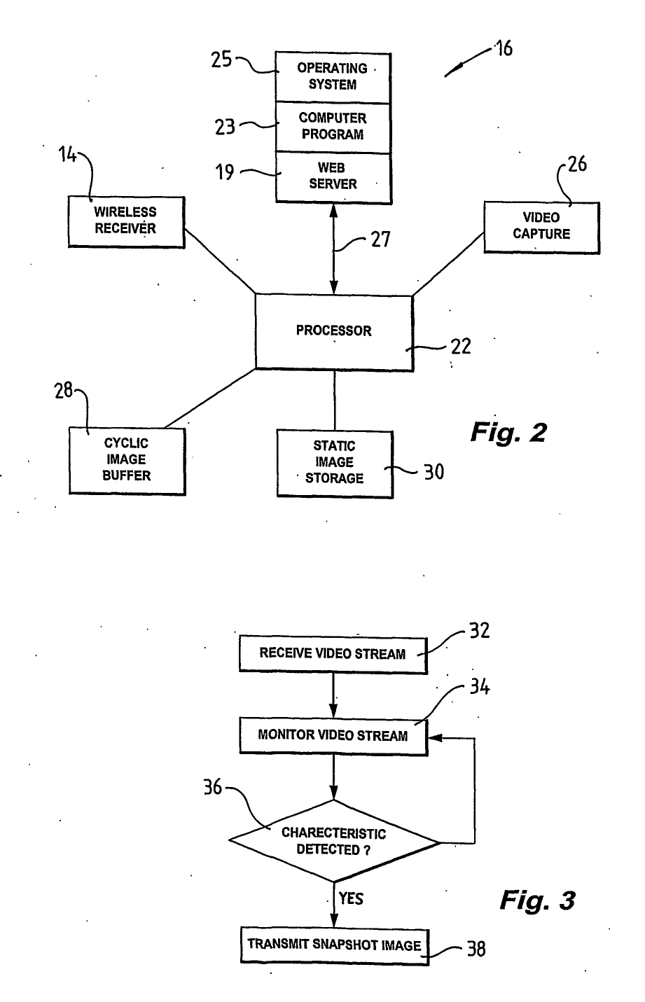

A high level view of the steps of the method carried out by the instruction of the computer program 24 when executed by the processor 22 is given by reference to FIG. 3. At step (31) a stream of video data is monitored. As noted above the stream includes encoded visual content being the optical information from the actual scene captured by the video camera and other information used, inter alia, to control the display of the visual content on a display device. This “non content” information may be inserted into the stream of video data by the video camera and is extracted from the stream in a similar manner to the visual content by the video capture device. When a characteristic is detected in the stream at step (32) snapshot image is transmitted over the Internet by the web server 18 to the remote viewers at step (34).

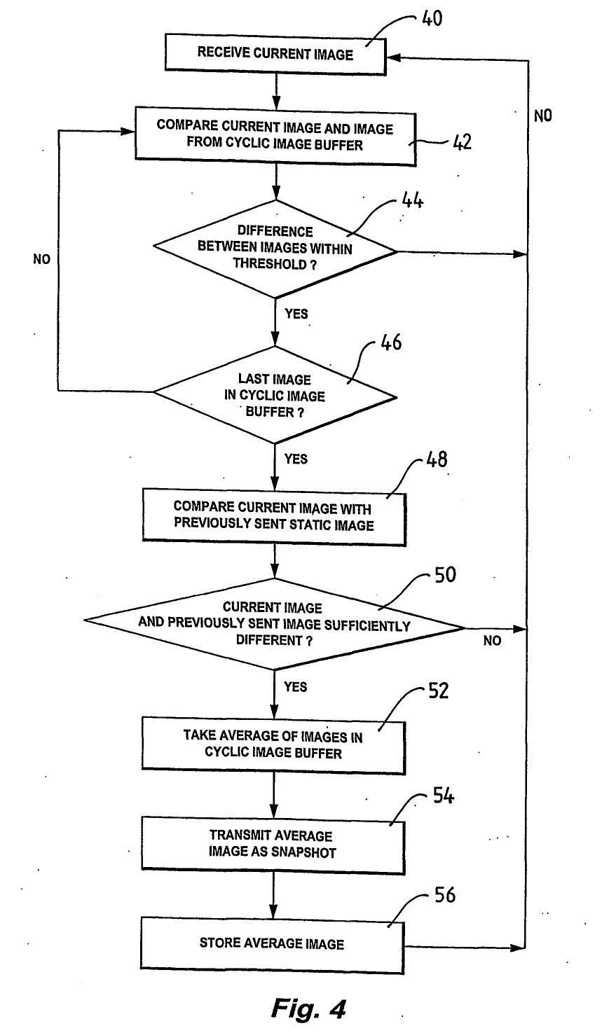

Turning to FIG. 4A, at step (31) the computer program 23 monitors the output from the video capture device in the manner described above. When the output is visual content, control passes to step (40), which is described in further detail below with reference to FIG. 4B. When the output is not visual content, at step (33) a determination is made of whether the output is a signal indicating that a snapshot request has been initiated at the video camera. In the event that a snapshot has been requested it is transmitted to the viewer in the manner described below (32).

Turning now to FIG. 4B a frame (“the current image”) is received from the video capture device and copied into the end of the cyclic image buffer. At step (42) the current image is compared with the image adjacent to the current image in the cyclic image buffer. The cyclic image buffer receives images from the video capture device that are chronologically ordered, so the adjacent image will have been captured by the camcorder before the current image.

The nature of the visual content captured by the camcorder is such that it is unlikely for two adjacent frames to be exactly the same in every respect, even if there is a static image captured in both the frames. Consequently the comparison between the current image and a compared image allows for differences within a prescribed tolerance threshold when determining if the images are the same. Where the differences between the current image and the compared image are greater than the threshold the processing returns to step (40) with a new image from the video capture device copied to the end of a cyclic image buffer becoming the current image, and the image at the front of the cyclic image buffer (being the oldest image) being removed from the cyclic image buffer.

Where the difference between the images is within the threshold, a further test is performed at step (46) of whether the compared image is the last image (ie. oldest image) in the cyclic image buffer. If the image is not the last image processing returns to step (42), with the current image being compared against the next oldest image in the cyclic image buffer. Alternatively, where the compared image is the last image in the cyclic image buffer processing moves to step (48) where the current image is compared with the most recent image sent to a viewer as a snapshot.

It will be realised that the current image must be within the acceptable difference threshold of each image in the cyclic image buffer before the snapshot transmission function will be triggered. In practice this results in a static image (ie. an image that is repeated over each frame in the cyclic image buffer) being transmitted to a viewer.

At step (50) a test is performed of whether the current image and most recently transmitted snapshot are sufficiently different. If the images are not sufficiently different a snapshot will not be sent to a viewer, as the viewer will already have a similar snapshot image. This allows for more efficient use of bandwidth between the server and the viewer.

Alternatively, if the current image and the previously sent image are sufficiently different, at step (52) an average of each image in the cyclic image buffer is taken. Averaging the images can result in an improved signal to noise ratio of the snapshot image transmitted to the viewer. In particular the signal to noise ratio should increase by the square root of the number of images in the cyclic image buffer.

At step (54) the average image is transmitted to the viewers as the snapshot image. Finally at step (56) the average image is stored in the static image storage as the most recently sent static image for comparison against later snapshot candidates.

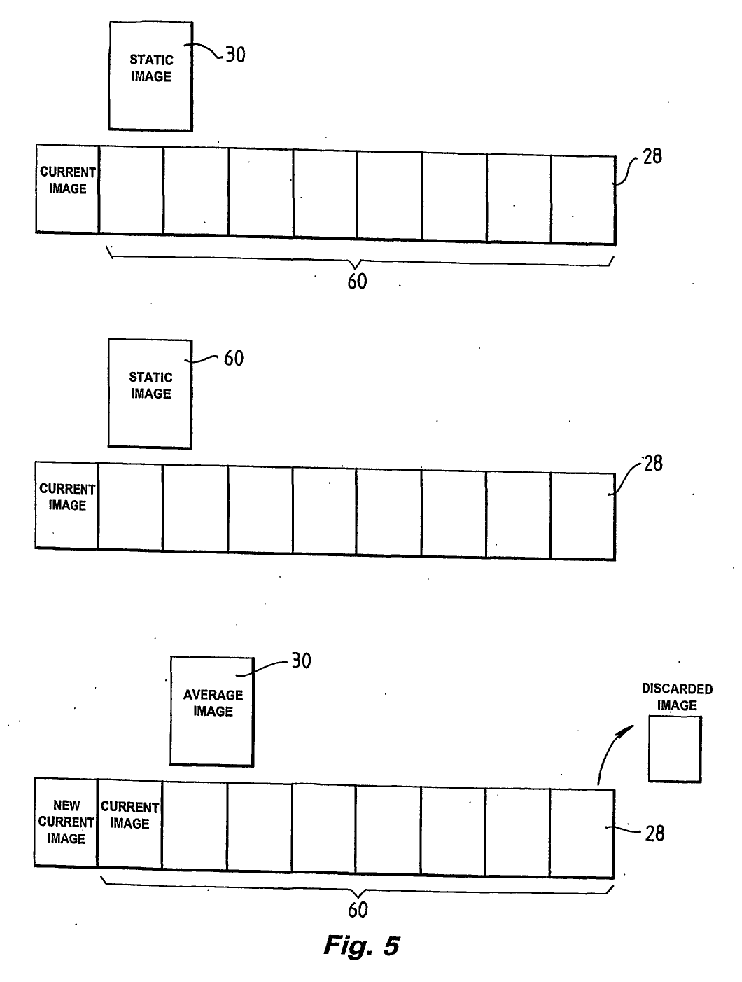

Turning to FIG. 5 it will be realised that the cyclic image buffer 28 behaves as a first-in-first-out (FIFO) queue. with a current image 29 “moving along” the queue as new frames enter the end of the queue from the video capture device 26, and frames at the front of the queue are discarded. This allows for continuous monitoring of the video stream for a particular characteristic. Additionally, the images in the cyclic image buffer are stored with the same resolution that was captured by the video camera. In contrast, the video stream transmitted to the viewer over the Internet can be stored at a reduced resolution to maximise bandwidth usage. As images leave the cyclic image buffer they may have their resolution reduced for compression and transmission over the Internet.

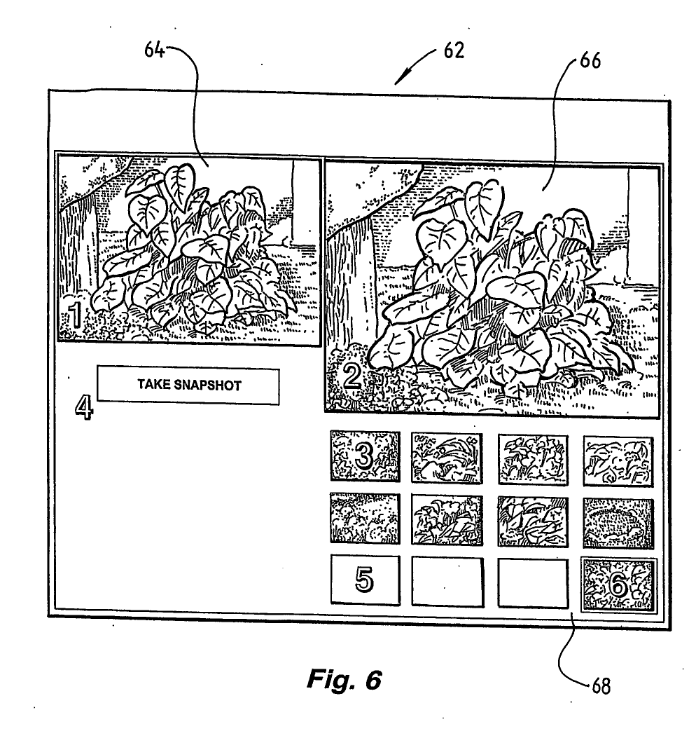

Turning to FIG. 6, a user interface 62 that is displayed on a client device 20 is illustrated. The viewer interface include a streamed video area 64 where the video from the camcorder is broadcast to the viewer in a conventional manner. Additionally, the user interface includes snapshot region 66 where the high resolution snapshots are received. In the embodiment of the invention just described the snapshot region 66 is updated with a new snapshot upon detection by the server of a characteristic in the video stream. When a new snapshot is received the older snapshot may be retained on the user interface 62 as a thumbnail sketch 68. Thumbnail sketches may also be numbered so that they may be easily retrieved by a viewer, for example, in responding to instruction given in the video streaming area 64.

The preferred embodiment of the invention as just described enables a wide range of commercial and non-commercial interactions. It can be provided as a hardware and software package that converts a camcorder into a wireless webcasting system.

In this form the invention allows real-time, virtual meetings between the vendor and its customers. Vendors can talk on the phone to customers while using a video camera to take video footage, which is immediately visible to the customer via the vendors' website.

The wireless technology allows difficult camera placements and unusual camera angles, so just about any view of the subject, product or event can be easily seen and in intense detail (using the snapshot function which enables the vendor and the viewer to capture high resolution stills at the click of a button).

Use of the invention overcomes the barriers of remoteness by allowing products to be presented live and online, reducing travelling costs, increasing productivity and improving market reach.

A snapshot image is used to allow the viewer to gain a clear, detailed image, accurate enough to allow for consultation, or purchase decision-making. Taking a snapshot also allows the user and viewer/s to emphasis a particular feature of interest. Snapshots may be numbered to allow easy reference.

The invention allows the most natural remote communication process. Using traditional fixed or mobile phone lines for audio communication means there are no, or minimal delays, which is important as research shows that more than ¼ second delay causes significant interference with the communication process.

The wireless technology allows the user to walk around freely without being tangled in cables, and the camcorder flip-out screen ensures that the user and viewer seeing the same subject matter. A viewer can request the operator of the camera to survey particular objects. Requests can be transmitted in various ways including fixed or mobile telephone, or over the Internet.

The wide range covered by the invention allows users to transmit images from a large area of their business, for example, large machinery sheds, livestock sheds, crop fields, paddocks, etc. This allows minimal disruption to the business (eg. items don't need to be moved to be viewed) and allows the user to seek specialist advice while keeping infected crops or livestock separated from ‘clean’ produce.

The snapshot functionality mimics the natural communication action of emphasis or pointing. As both the user and the viewer have the ability to trigger a snapshot which can be viewed by all involved in the session, this serves to allow all parties involved in the session to use a snapshot to ‘point’ to particular views of a product, which clearly communicates what is subject of discussion.

All users can also view ‘session’ thumbnails as separate from individually requested thumbnails, and these are numbered. This allows users to refer to previous subjects eg. “if you compare flower in thumbnail 5 to the one in thumbnail 8, it is much healthier.” This allows all viewers to easily compare a number of products or subjects.

The invention can be used for:

Marketing and Selling Goods:

It can be very difficult for producers of perishable products of variable quality (eg. fruit, plants, livestock) to sell sign unseen to a buyer, which represents an enormous problem for businesses that are attempting to reach markets outside their local area. Wholesale nurseries, particularly ones with large and varied product ranges continually face this issue because plant quality varies so much, so quickly. Standard practice is that the wholesaler drives a van of their latest products around to all the buyers to display their product (the ‘spec truck’), and then the buyers place their orders on the spot. This is a very time consuming process, the travel costs are high, plants will often not look their best due to travel stress, and it requires: a staff member to be out on the road and not in the nursery.

With the invention, buyers can view the produce from their desks—it's easier for them, and much easier for the nurseryman. The interactive nature of the invention means that buyers can instruct the vendor to show them all aspects of the plant (including root system etc.) and they can use the snapshot feature to gain accurate images of plant colour etc.

Also, by cutting out the previously necessary travel for sales meetings, an online meeting with a client can be held at short notice, greatly reducing the length of the sales cycle.

Communications with the Export Market:

One of the major barriers recognised for businesses trying to access export industries is access to, and communication with export markets, particularly for sellers of livestock and perishable goods such as fruit, vegetables and plants.

For example, a cherry grower in Tasmania exports their goods around Australia, and also overseas. The invention allows the grower to walk around his orchard, packing room, and transport equipment and not only show the potential buyer his produce, but also how that produce will be stored, packed and transported to the client. The snapshot feature allows the client to inspect the fruit for colour, blemishes, disease size. Also, the interactivity of the process allows the client to request to view particular angles of equipment, trees or fruit.

The invention allows vendors to develop personalised ‘face-to-face’ relationships with buyers, and display all aspects of their goods, and the related production, growing, storage and transport facilities. Such visual inspections and transparency of business processes builds confidence and understanding between vendors and buyers. The invention greatly improves market reach at minimal cost, and in a time-effective manner.

Provision of Remote Technical and Mechanical Support Remotely:

Technical downtime represents a substantial expense to large machinery companies. For example, the majority of mining industry sites are located in remote areas, and due to the high cost of replacement parts, don't carry full replacement parts at all sites. When a technical issue is faced, either the onsite staff would send the failed part back to the manufacturer and request a replacement, or call for onsite assistance from a technical specialist. However, this is a costly and time-consuming process, the available technical specialists are limited and mechanical downtime can represent tens of thousands of dollars lost revenue per hour.

The invention will allow onsite staff to use live video to display equipment operation or damage to mechanical support specialists located at other sites, allowing them to quickly identify what action or parts are required to ensure that equipment is back up and running fast to minimise the expense of downtime. The flexibility allowed using a wireless solution allows video and snapshots of all angles of ‘hard to reach’ machinery. The live, interactive nature of the invention allows the technical specialist to direct the onsite staff to try possible solutions, replace parts and generally perform a range of troubleshooting actions which can provide a solution or allow the mechanical support specialist to identify the fastest way repair the system and return to normal production levels.

This process saves the company travel costs and minimises downtime, and increases the productivity of technical support specialists.

Provision of Remote Medical Consultation:

The invention allows medical practitioners who are separated by distance to make a detailed consultation of a patient, utilising video and high resolution stills to make a diagnosis and agree on a course of action. This is particularly useful due to the demand on specialists who are often based in metro areas. This allows remote specialist consultation to medical facilities in rural, remote areas around the world.

Provision of Remote Veterinarian Services:

The invention will be used by veterinarians to allow remote consultation and diagnoses, but also instruct and undertake autopsies. Eg. the invention will be used by a pig veterinarian specialist to instruct a onsite pig farmer to perform an autopsy (which must be performed within hours after the death) remotely. The pig veterinarian can take and save snapshots as a record of the autopsy, which can then be used to compare with future autopsy, and identify patterns, new diseases etc. The wireless functionality and use of a camcorder allows a flexible range of camera angles, and allows the user to perform the initial diagnoses and autopsy at the site of death, to avoid possible infection of other animals.

Provision of Agricultural Consultation Services:

Agricultural consultation is available in many fields, however, specialists in many areas are limited, and it is not cost or time effective to engage a specialist consultant to travel to a specific location to inspect livestock, plants etc. especially as the symptom may only be present temporarily (eg. a cow with the initial signs of a disease will have moved to a secondary stage by the time a consultant is available to inspect it.).

For example, the invention can be used for a plant grower in regional Victoria, Australia to consult with a Calla Lilly specialist in New Zealand about an issue with leaf discolouration in a crop of Calla Lillies. The specialist can make a diagnoses and recommend a course of action after instructing the grower to show various views of the plant, allowing him/her to gather the appropriate snapshots to display a detailed view of a variety of aspects of the plant. The consultant is then able to regularly monitor the progress of the crop—from New Zealand.

In a second embodiment of the invention the snapshot functionality could be triggered by a user acting directly at the server or camcorder to trigger the snapshot functionality.

The word ‘comprising’ and forms of the word ‘comprising’ as used in this description and in the claims does not limit the invention claimed to exclude any variants or additions. Modifications and improvements to the invention will be readily apparent to those skilled in the art. Such modifications and improvements are intended to be within the scope of this invention.

1. A method of providing visual information to a viewer, comprising the steps of:
(a) receiving at a receiver, a stream of video data transmitted from a video camera;
(b) receiving and monitoring the stream at a server connected to the receiver;
(c) transmitting the stream from the server to one or more remote viewers over a communications network; and
(d) transmitting a snapshot image to one or more remote viewers in response to the detection of a characteristic in the stream.

2. A method according to claim 1 wherein the characteristic is a signal indicating that a snapshot request has been initiated at the video camera.

3. A method according to claim 2 wherein the initiation is by actuation of a button on the video camera.

4. A method according to claim 1 wherein the characteristic is an attribute of the visual content of the stream.

5. A method according to claim 4 wherein the attribute is the repletion of a substantially static image.

6. A method according to claim 5 wherein the substantially static image is detected by comparing a frame to a plurality of other frames in the stream, wherein the substantially static image is detected when the frame is similar to each of the other frames.

7. A method according to claim 6 wherein the frame was captured by the video camera after each of the other frames.

8. A method according to claim 7 further including the steps of:
including the frame in the plurality of other frames after it has been compared to the plurality of other frames; and
removing a frame from the plurality of other frames.

9. A method according to claim 8 wherein the frame removed from the plurality of other frames is the earliest frame captured by the video camera.

10. A method according to claim 6 wherein the frame is determined to be similar to another frame notwithstanding differences between the frames, where those differences are within a prescribed difference tolerance.

11. A method according to claim 6 wherein the snapshot image transmitted to the viewer is an average frame calculated from the frame and each of the other frames.

12. A method according to claim 6 further including the steps of:
comparing the frame to the most recently transmitted snapshot image; and
transmitting a further snapshot image only when the frame and the most recently transmitted snapshot image are sufficiently different.

13. A method according to claim 1 further including the step of storing each transmitted snapshot image at a client device of the viewer for retrieval and viewing.

14. A method according to claim 1 wherein the resolution of the snapshot image is higher than the resolution of the frames in the stream.

15. Computer program code comprising:
(a) instructions for receiving a stream of video data;
(b) instructions for transmitting the stream to one or more remote viewers over a communications network;
(c) instructions for monitoring the stream; and
(d) instructions for transmitting a snapshot image to one or more remote viewers in response to the detection of a characteristic in the stream.

16. Computer program code according to claim 15 wherein the characteristic is a signal indicating that a snapshot request has been initiated at the video camera.

17. Computer program code according to claim 16 wherein the initiation is by activation of a button on the video camera.

18. Computer program code according to claim 15 wherein the characteristic is an attribute of the visual content of the stream.

19. Computer program code according to claim 18 wherein the attribute is the repletion of a substantially static image.

20. Computer program code according to claim 19 including instructions for detecting the substantially static image by comparing a frame to a plurality of other frames in the stream, wherein the substantially static image is detected when the first frame is similar to each of the other frames.

21. Computer program code according to claim 20 wherein the frame was captured by the video camera after each of the other frames.

22. Computer program code according to claim 21 further including:
instructions for including the first frame in the plurality of other frames after it has been compared to the plurality of other frames; and
instructions for removing a frame from the plurality of other frames.

23. Computer program code according to claim 22 wherein the frame removed from the plurality of other frames is the earliest frame captured by the video camera.

24. Computer program code according to claim 20 including instructions for determining that the frame is similar to another frame notwithstanding differences between the frames where those differences are within a prescribed difference tolerance.

25. Computer program code according to claim 20 including instructions for transmitting an average frame calculated from the frame and each of the other frames to the viewer as the snapshot image.

26. Computer program code according to claim 15 including instructions for storing each transmitted snapshot image at a client device of the viewer for retrieval and viewing.

27. Computer program code according to claim 15 including instructions for providing a snapshot image having a resolution higher than the resolution of the frames in the stream.

28-87. (canceled)
